(19) United States
(12) Patent Application Publication
(10) Pub. No.: US 2014/0229298 A1
(43) Pub. Date: Aug. 14, 2014

(54) Determining Whether Ad-Blocking Software is Executing on a Client Device

(71) Applicant: NAVTEQ B.V., Veldhoven (NL)

(72) Inventor: Raimund Grun, Schwalbach (DE)

(73) Assignee: NAVTEQ B.V., Veldhoven (NL)

(21) Appl. No.: 13/763,356

(22) Filed: Feb. 8, 2013

(51) Int. Cl. G06Q 30/02

(52) U.S. Cl. CPC G06Q 30/0241
USPC 705/14.73

(57) ABSTRACT

Determination of whether ad-blocking software is executing on a client device may be provided. Advertising content from an advertising server may be received at a client device. The advertising content may be provided in a client application executing on the client device and may have information embedded therein. The client device may attempt to detect the information embedded within the advertising content. Based on the attempted detection, it may be determined whether ad-blocking software is executing on the client device. When it is determined that ad-blocking software is executing on the client device, a remedial action may be performed.

### BACKGROUND

The present embodiments relate to ad-blocking software.

Many applications for smart phones and portable navigation devices utilize ad-funded pricing models. Accordingly, the application developer may integrate advertising functionality into or with the application, which, in turn, may display advertisements in or as part of the application. In return, the application developer may receive compensation from advertisers for displaying these advertisements. This compensation may allow the developer to recoup development and maintenance costs, such that the developer may allow the application to be downloaded and used, free of charge or at a reduced rate, by an end user of the smart phone or portable navigation device.

In response, ad-blocking software has been developed that, once installed by the end user, removes or limits advertisements from these applications. This ad-blocking software may accomplish this goal in several different ways. The ad-blocking software may interrupt the communications between the advertising server and the smart phone or portable navigation database. For example, the ad-blocking software may tweak the hosts file for the smart phone or portable navigation device. Since the advertising server may not be contacted, the advertisements are not received from the advertising server and, as such, are not displayed. The ad-blocking software may allow query for, but prevent display of, the advertisements from the advertising server. Instead of displaying the advertisements, the ad-blocking software may, for example, replace the advertisement with a transparent image.

Although ad-blocking software may be beneficial to the end users of smart phones and portable navigation devices, who, by using this software, are no longer forced to view undesirable advertisements, the use of ad-blocking software damages the ad-funded pricing models on which application developers rely. Since ad-blocking software limits or totally prevents advertisements from being displayed, advertisers may be less willing to advertise their products and/or services and/or pay application developers for displaying their advertisements. In turn, application developers may be unable to recoup development and maintenance costs for providing and maintaining their applications.

### SUMMARY

To address these and other objectives, the present embodiments relate to determining whether ad-blocking software is executing on a client device.

A method for determining whether ad-blocking software is executing on a client device may be provided. Advertising content from an advertising server may be received at a client device. The advertising content may be provided in a client application executing on the client device and may have information embedded therein. The client device may attempt to detect the information embedded within the advertising content. Based on the attempted detection, it may be determined whether ad-blocking software is executing on the client device. When it is determined that ad-blocking software is executing on the client device, a remedial action may be performed.

### BRIEF DESCRIPTION OF THE DRAWINGS

Exemplary embodiments of the present invention are described herein with reference to the following drawings:

FIG. 1 depicts a block diagram of one embodiment of a system for determining whether ad-blocking software is executing on a client device;

FIG. 2 depicts a more detailed view of an exemplary client device of the system of FIG. 1;

FIG. 3 depicts a flow chart showing one embodiment of a method for determining whether ad-blocking software is executing on a client device;

FIG. 4 depicts a flow chart showing another embodiment of a method for determining whether ad-blocking software is executing on a client device; and

FIG. 5 depicts an exemplary computer system for use with the system of FIG. 1.

### DETAILED DESCRIPTION OF THE PRESENTLY PREFERRED EMBODIMENTS

The present embodiments aim to provide methods, computer readable storage media with instructions, and systems for determining whether ad-blocking software is executing on a client device. To make this determination, information embedded within advertising content received from an advertising server and to be provided in a client application running on the client device is detected and/or communications data about or for the client device is obtained.

Any of various reactions or remediation may occur in response to detecting ad-blocking software. An end user of the client device may be informed of this determination, prompting an end user of the client to respond or risk having the client application limited, or the client application may be limited in some way. In turn, the present embodiments may vitiate the effectiveness and/or usage of ad-blocking software on client devices. This may allow application operators to continue relying on ad-funded pricing models, which allows operators to provide applications free of charge or at a reduced price, and at the same time recoup development and maintenance costs for providing and maintaining their applications.

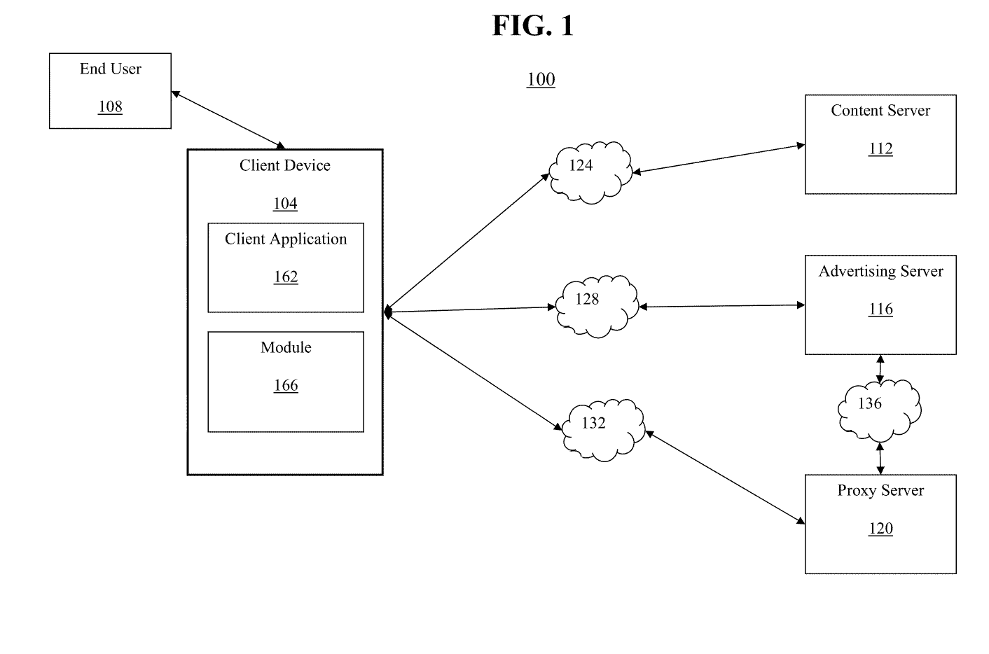

FIG. 1 shows a block diagram of one embodiment of a system 100 for determining whether ad-blocking software is executing on a client device. The system 100 generally includes a client device 104 associated with (e.g., owned or operated by) an end user 108, a content server 112, an advertising server 116, and one or more proxy servers 120. In other embodiments, the system 100 may include additional, different, or fewer components. For example, additional client devices 104, end users 108, content servers 112, advertising servers 116, proxy servers 120, or combinations thereof, may be provided. As another example, the system 100 need not include the one or more proxy servers 120. As yet another example, the content server 112 and the advertising server 116 may be combined or integrated into one server.

The client device 104 is in communication with or coupled to the content server 112 via a wired or wireless communication network 124, the client device 104 is in communication with or coupled to the advertising server 116 via a wired or wireless communication network 128, the client device 104 is in communication with or coupled to the one or more proxy servers 120 via a wired or wireless communication network 132. The one or more proxy servers 120 are, in turn, in communication with or coupled to the advertising server 116 via a wired or wireless communication network 136. As used herein, the phrases “in communication” and “couple” include directly connected to or indirectly connected through one or more intermediate components. Such intermediate components may include hardware and/or software based components.

The content server 112 may be any type of server, such as a database server, a file server, a web server, or other server. The content server 112 may include one or more computers and/or may be part of a larger network of servers. The content server 112 is operative to store or maintain digital or electronic content provided by one or more content providers (e.g., developers). The content server 112 may, for example, maintain a database from which content may be generated (i.e. the content server 112 is a “website”) or maintain an index of content from which content may be produced in response to specific search queries (i.e. the content server 112 is a search engine). The digital content may be or include news, sports information, event information, city, state, or municipal information (e.g., attractions, emergency information, etc.), gaming content, map information, navigation information, other information or data, or combinations thereof, to be provided to an application executable on the client device 104. The digital content may include or be text, one or more images, video content (e.g., one or more videos or video clips), audio content, other content, or combinations thereof, stored in any number of different formats (e.g., HTML, JPEG, Bitmap, Tiff, SVG, AVI, MOV, MPG, WMV, MP3, WAV, etc.)

The content server 112 may provide or output the digital content directly to the client device 104 via the network 124. Alternatively, or in addition thereto, the content server 112 may provide or output the digital content indirectly to the client device 104 via, using, or through one or more proxy servers (e.g., the one or more proxy servers 120).

The advertising server 116 may be any type of server, such as a database server, a file server, a web server, or other server. The advertising server 116 may include one or more computers and/or may be part of a larger network of servers. The advertising server 116 is operative to store or maintain advertising content or data. The advertising content or data is provided by one or more advertisers and may include product and/or service advertising or marketing content, such as, for example, product or service information, store or restaurant listings, financial incentives (e.g., coupons, rebates, discounts, or deals), or combinations thereof, associated with one or more products and/or services. The advertising content may or may not be relevant to or associated with some or all of the digital content and/or the end user 108 of the client device 104. For example, some advertising content may be tailored to specific digital content and/or the end user 108. The advertising content may include or be text, one or more images, video content (e.g., one or more videos or video clips), audio content, other content, or combinations thereof, stored in any number of different formats (e.g., HTML, JPEG, Bitmap, Tiff, SVG, AVI, MOV, MPG, WMV, MP3, WAV, etc.).

The advertising content includes information or data embedded (e.g., encoded), therein. In other words, information is embedded in or placed within the advertising content. The information may be used to determine whether the advertising content is actually provided to the end user 108 and, in turn, whether ad-blocking software is executing or running on the client device 104. The information may be or include a code, an address, a tag, other information or data, or combinations thereof. In one embodiment, the information is a checksum code (e.g., md5sum). The information may or may not be visible to the end user 108 when the advertising content is provided. The information may be embedded anywhere in the advertising content. The information may, for example, be embedded into or within graphics, such as one or more layers, channels, or pixels, of the advertising content. In one embodiment, the information is embedded into an alpha channel (e.g., an 8-bit alpha channel, a 1-bit alpha channel) of the advertising content. When, for example, the advertising content is or includes one or more images and the information is a checksum code, the checksum code may be embedded or encoded into the alpha channel of the first row of pixels in one or more advertising images.

The information may be embedded in the advertising content at any time, such as, for example, before the advertising server 116 obtains or receives the advertising content, when the advertising content is received or obtained from the one or more advertisers, after the advertising content is stored on the advertising server 116, or before the advertising content is to be provided to the client device 104. The information may be embedded by the advertising server 116, by the one or more advertisers, or by another party or entity (e.g., a programmer).

The advertising server 116 may provide or output the advertising content, including the information embedded therein, directly to the client device 104 via the network 128. Alternatively or in addition thereto, the advertising server 116 may provide or output the advertising content, including the information embedded therein, indirectly to the client device 104 via, using, or through one or more proxy servers (e.g., the one or more proxy servers 120).

Each of the one or more proxy servers 120 may be any type of proxy server (e.g., a web proxy server). Each proxy server 112 may include one or more computers and/or may be part of a larger network of servers. One or more of the proxy servers 120 may be used to allow the content server 112 and/or the advertising server 116 to indirectly connect and provide digital content and/or advertising content, respectively, to the client device 104. Alternatively, or in addition thereto, one or more of the proxy servers 120 may be used by a module to assist in the determination of whether advertising content from the advertising server 116 was or is being properly displayed on or by the client device 104.

The networks 124, 128, 132, 136 may be wireless networks, wired networks, or combinations of a wired and wireless network, such as a cellular telephone network and/or 802.11x compliant network, and may include a publicly accessible network, such as the Internet, a private network, or combination thereof. In one embodiment, the network 124 may be the same as the network 128, the network 132, the network 136, or combinations thereof. In other embodiments, one or more of the networks 124, 128, 132, 136 may be the same network. The type and configuration of the communications networks 124, 128, 132, 136 are implementation dependent, and any type of communications network which facilitates the described communications between the client device 104 and the content server 112, between the client device 104 and the advertising server 116, between the client device 104 and the one or more proxy servers 120, and between the one or more proxy servers 120 and the advertising server 116, available now or later developed, may be used.

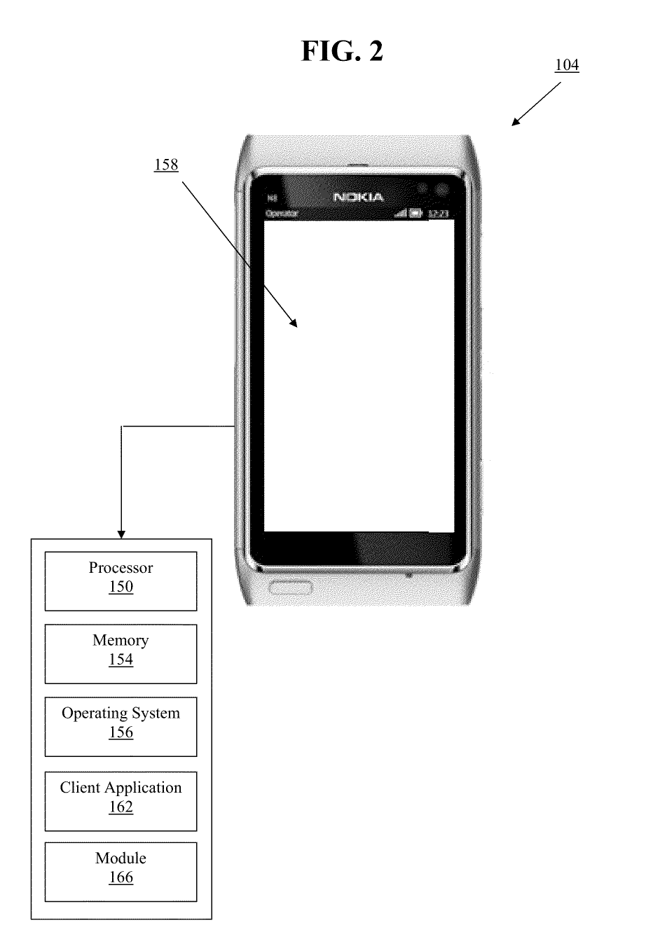

FIG. 2 shows one embodiment of the client device 104. In this embodiment, the client device 104 is a mobile device (e.g., manufactured by Nokia Corp.), such as a smart phone, a mobile phone, a personal digital assistant (“PDA”), a tablet computer, a notebook computer, a personal navigation device (“PND”), a portable navigation device, and/or any other known or later developed portable or mobile device, associated with the user 108. In other embodiments, the client device 104 may be a desktop computer, workstation, or any other known or later developed non-portable or non-mobile client device associated with the user 108.

As shown in FIG. 2, the client device 104 includes a processor 150, a memory 154, an operating system 156, a display 158, a software application 162, and a module 166. The client device 104 may or may not include ad-blocking software installed and executable on the operating system 156. In other embodiments, the client device 104 may include additional, fewer, or different components. For example, the client device 104 may include additional software applications 162 and additional modules 166.

The processor 150 may be a general processor, a digital signal processor, ASIC, field programmable gate array, graphics processing unit, analog circuit, digital circuit, combinations thereof, or any other known or later developed processor. The processor 150 operates pursuant to instructions in the memory 154.

The memory 154 may be a volatile memory or a non-volatile memory. The memory 154 may include one or more of a read only memory (ROM), random access memory (RAM), a flash memory, an electronic erasable program read only memory (EEPROM), or other type of memory. The memory 154 may include an optical, magnetic (hard drive) or any other form of data storage device.

The operating system 156 is installed on or in the memory 154 of the client device 104 or a separate memory. The operating system 156 may be Linux, Microsoft Windows, Android, iOS,Windows CE, MAC OS X, or any other operating system.

The display 158 may be a liquid crystal display (LCD) panel, light emitting diode (LED) screen, thin film transistor screen, or another type of display. The display 158 is operable to display to the end user 108 content (e.g., digital content, advertising content) obtained or received from the content server 112, the advertising server 116, the one or more proxy servers 120, or combinations thereof. The display 158 outputs content based on the software application 162. The content may be intended to include advertising content.

The software application 162 is provided (e.g., created, developed) by an application operator (e.g., software developer). In these embodiments, the application operator utilizes an Ad-funded pricing model, and, as such, provides the software application 162 to the end user 108 and other end users free of charge or at a reduced cost. In other embodiments, however, the application operator may utilize a different type of pricing model and may, as a result, provide the software application 162 to the end user 108 and other end users at a normal or market cost, yet still provide advertising content.

The software or client application 162 may be any application that is installed and executable on the operating system 156 of the client device 104 and provides (e.g., presents, outputs) the associated end user 108 with, or allows the end user 104 to receive or use, digital or electronic content and/or advertising content from the content server 112 and/or the advertising server 116.

The software application 162 may be a Web browser (e.g., Firefox, Internet Explorer), an email application, a messaging application, a multimedia player (e.g., Windows Media Player), a game (e.g., Jeopardy), or other plug in or proprietary application built into or installed on the operating system 156. When, for example, the client device 104 is a mobile or smart phone, the software application 162 may be any type of mobile or smart phone application (“app”) (e.g., the Starbucks app, the Weather Channel app, the Angry Birds app). The software application 162 may be built into or bundled with (i.e., come with) the client device 104 or may be downloaded or obtained (e.g., purchased) by the end user 108 and installed on the client device 104 after the client device 104 has been purchased or otherwise acquired. The software application 162 may be written in a suitable computer programming language such as C, although other programming languages (e.g., C++, Java, etc.) are also suitable.

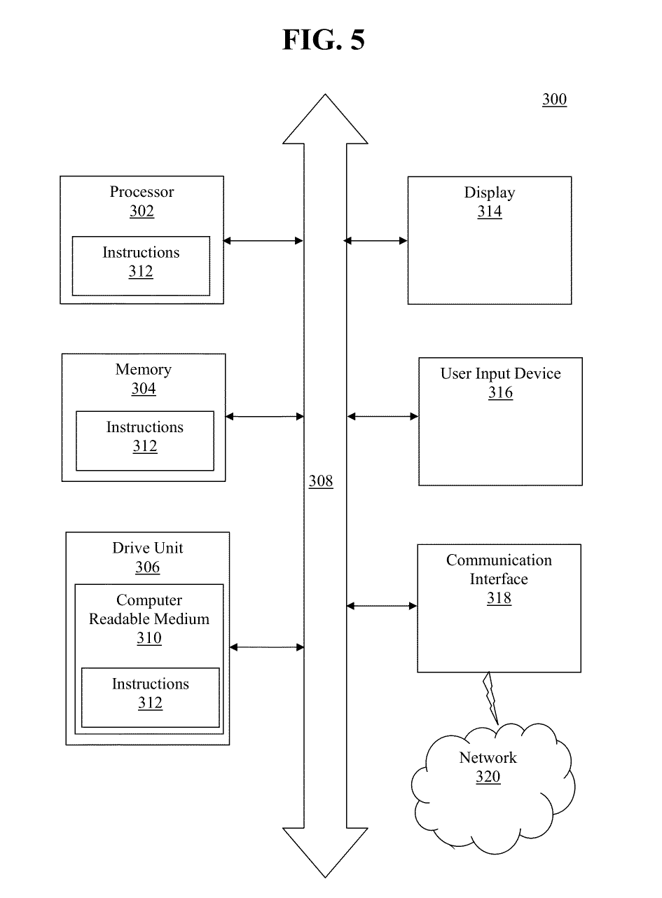

The module 166 is also installed and executable on the client device 104 and facilitates or assists with the determination of whether ad-blocking software is installed on the client device 104. For example, the module 166 is an application or algorithm that facilitates or assists with the determination of whether the client device 104 is able to obtain advertising content from the advertising server 116 and that advertising content received or obtained from the advertising server 116 is properly provided (e.g., displayed, presented, or output) at the appropriate time, in the software application 162. The module 166, or components thereof, may be installed on or built into the operating system 156, may be installed within or built into the software application 162, or a combination thereof. In one embodiment, the module 166 (or individual components thereof, as described below) may be implemented as computer program logic or computer readable program code stored in the memory and/or storage of a computer, such as the computer 300 described below with respect to FIG. 5, and executable by one or more processors thereof to implement the disclosed functionality.

The module 166 may be built into or bundled with (i.e., come with) the client device 104 or may be downloaded or obtained by the end user 108 after the client device 104 has been purchased or otherwise acquired. For example, the application 166 may be downloaded and installed by the end user 108 at the same time as the client application 162 (e.g., the developer for the client application 162 may require this or bundle the application 166 with the client application 162). The algorithm 166 may automatically execute on the client device 104 when the client device 104 is powering up, when the software application 162 is loading or initializing, in response to a request from the advertising server 116, or in response to some other trigger or event. As with the software application 162, the application 166 may be written in a suitable computer programming language such as C, although other programming languages, such as C++ or Java, are also suitable.

With reference again to FIG. 1, when the software application 162 is executing or running on the client device 104, the software application 162 is configured to request, and the content server 112 is configured to provide to the software application 162, digital or electronic content. Once the software application 162 obtains or receives the digital content from the content server 112, the software application 162 is configured to, simultaneously or at a later time, provide (e.g., display, via the display 158), the digital content to the end user 108 of the client device 104. The end user 108 is thus allowed or permitted to receive or use the digital content and/or request additional digital content from the content server 112.

When or while the software application 162 is running on the client device 104, the client device 104, particularly the software application 162, may transmit a request for advertising content to the advertising server 116. The request may be transmitted directly to the advertising server 116 or via one or more of the proxy servers 120. The content server 112 may alternatively request that advertising content be sent to the client device 104. In response to or based on the request, the advertising server 116 may transmit advertising content to the client device 104. In other embodiments, the advertising content may be transmitted to the client device 104 without any specific request. The advertising content may be directly transmitted to the client device 104 and/or may be indirectly transmitted to the client device 104 using or through one or more of the proxy servers 120 or the content server 112. The transmission of the advertising content to the client device may be conducted in any known manner. In some embodiments, the advertising content is transmitted using or via the secured Domain Name Service (“DNSsec”) in order to prevent Domain Name Service (“DNS”) spoofing, which may be attempted to provide (e.g., deliver) fake advertising content from the wrong server (i.e., not the advertising server 116).

The transmitted advertising content may or may not be associated with the digital content provided by the software application 162 and/or the end user 108. The transmitted advertising content is configured to be provided (e.g., output, displayed) in the software application 162. The advertising content may be provided with or without the digital content. For example, the advertising content may be configured to be displayed in combination with the digital content. Depending on the format of the advertising content, the advertising content may be configured to be displayed to the end user 108 as a webpage, a screenshot, an ad banner or window, scrolling text, an information page, other image, or video, may be configured to be output to the end user 108 as audio or video, in some other way, or combinations thereof.

In some cases, such as when no ad-blocking software (e.g., AdBlock Plus) is executing on the client device 104, or the ad-blocking software is ineffectual, the software application 162 may receive or obtain and provide the advertising content to the end user 108 without issue. In turn, the advertisers associated with the advertising content may compensate the application operator for providing the advertising content, allowing the application operator to continue providing the software application 162 free of charge or at a reduced cost.

When, however, ad-blocking software is executing on the client device 104, the ad-blocking software may prevent the client device 104, particularly the client application 162, from receiving, obtaining, or otherwise acquiring the advertising content, and/or may prevent the provision of the advertising content to the end user 108. Depending on which type of ad-blocking software is installed, the ad-blocking software may interrupt the communications (whether direct or indirect) between the advertising server 116 and the client device 104 (particularly the software application 162), or may request but not actually provide the advertising content. In either case, the ad-blocking software may prevent the software application 162 from providing at least some of the advertising content to the end user 108. As a result, the application operator may be unable to recoup the development costs and/or maintenance costs associated with the software application 162. This may, for example, force the application operator to charge or charge more for providing the software application 162.

To prevent such an undesirable situation, the system 100 may, using or via the advertising server 116 and the module 166, determine whether ad-blocking software is executing or running on the client device 104 (i.e., determine whether the client device 104 is able to obtain or receive advertising content and/or whether obtained advertising content has been provided to the end user 108 by the client device 104). When it is determined that ad-blocking software is executing on the client device 104, the module 166 may prompt the end-user 108 to take action and/or limit the client application 162 as described below.

Accordingly, when the advertising server 116 transmits advertising content to the client device 104, the module 166 may be configured to help determine whether the advertising content is actually provided in the client application 162. In other words, the module 166 may be configured to help the advertising server 116 verify that the advertising content is actually provided to the end user 108 in the client application 162. This determination or verification may, in turn, be indicative of whether ad-blocking software is executing on the client device 104.

To this end, the module 166 is configured to attempt to detect, determine, or identify the information embedded within the advertising content. In general, the module 166 is able to detect or identify the embedded information when the advertising content has actually been provided in the client application 162. When the module 166 detects, decodes, extracts, or identifies the information embedded within the advertising content, this means that the advertising content was actually provided in the client application 162.

In some embodiments, the module 166 is configured to decode or decipher the advertising content, particularly the graphics of the advertising content, when or after the advertising content has been output, displayed, or provided in the software application 162. More specifically, the module 166 is configured to decode or decipher the layers, channels, pixels, other graphics components, or combinations thereof, of the advertising content. In one embodiment, the module 166 is configured to decode the alpha channel of the advertising content. Once the module 166 decodes the graphics of the advertising content, the module 166 may detect and/or extract the previously embedded information from the advertising content. When, for example, the embedded information is or includes a code (e.g., a checksum code), the module 166 may detect and extract that code from the advertising content. In one embodiment, the embedded information is an md5 checksum or MD5sum code inserted into the alpha channel of the advertising content. Other checksum algorithms or codes may be used. Once the module 166 decodes the alpha channel, the module 166 may detect and/or extract this md5sum checksum code from the alpha channel. In other embodiments, tags, identifiers, other codes, other information, or combinations thereof, may be detected and/or extracted.

Alternatively or in addition thereto, the module 166 is configured to detect, check, or otherwise determine whether the embedded information has been provided on (e.g., overlaid) or along with the advertising content. When, for example, the embedded information is a code or an address configured to be provided with the advertising content, the module 166 may determine or detect whether the code or the address was provided with the advertising content. When the code or address is provided with the advertising content, the code or address may or may not actually be visible to the end user 108. For example, the code or address may not be recognizable by the end user 108.

The advertising server 116 and the module 166 may, alternatively or additionally, be configured to determine whether the client device 104 is able to obtain or receive advertising content from the advertising server 116 in the first place. In other words, the advertising server 116 and the module 166 may be configured to attempt to determine whether ad-blocking software is executing on the client device 104 and is therefore interrupting or otherwise preventing communication between the client device 104 and the advertising server 116. To this end, the module 166 may be configured to collect, gather, or otherwise obtain communications data (i.e., data indicative of communication connectivity, such as mobile internet connectivity, wireless internet connectivity) of or for the client device 104.

This communications data is generally indicative of whether the client device 104 is or is not able to communicate with the advertising server 116 (either directly or indirectly). The communications data for the client device 104 may include data indicative of whether the client device 104, such as a mobile device, has access to a mobile internet connection (e.g., whether mobile internet is turned on, whether a mobile internet connection is available) and/or a wireless internet connection (e.g., whether WiFi is turned on for or at the client device 104, whether a wireless internet connection is available). For example, the communications data may include data indicating that the client device 104 does not have access to a mobile internet connection (e.g., the client device 104 is inside a building), and/or a wireless internet connection (e.g., the client device 104 may only connect to free or private WiFi). The communications data may, in addition or alternatively, include data indicative of a location or position of the client device 104 and/or whether the client device 104 is roaming or is near an area in which roaming is necessary. Furthermore, the communications data may include data indicative of one or more previous connections (i.e., successful connections) between the client device 104 and the advertising server 116 and/or one or more previous connections (i.e., successful connections) between the client device 104 and one or more of the proxy servers 120. Other data may be collected as well.

In this embodiment, the module 166 is configured to collect this data when the module 166 detects or determines that the client application 162 has been executing or running on the client device 104 for a pre-determined or specified period of time (e.g., 15 minutes). In other embodiments, however, the module 166 may collect this data at pre-determined intervals (e.g., every 4 hours), in response to a request (from, e.g., one or more of the proxy servers 120 and/or the software application 162), or in response to some other trigger.

In the embodiments in which the advertising content is transmitted using the DNSec to prevent DNS spoofing, the module 166 may store or maintain a list of IP addresses corresponding to the advertising server 116 and other advertising servers 116, as well as a name of the advertising server 116 associated with each IP address. In turn, if the DNS returns an incorrect or wrong IP address, the hosts file includes an incorrect IP address for a given advertising server name, or some other error occurs, this may indicate that an attempt to block advertising content has occurred, and, thus that ad-blocking software is installed on the client device 104. This information may be included in the data transmitted by the module 166 to the content server 112 or the advertising server 116 and the data analyzed by the content server 112 or the advertising server 116.

Data indicative of whether the advertising content has been provided in the client application 162 (e.g., the extracted information, such as the md5sum checksum) and/or any communications data collected by the module 166 may, in some embodiments, be compressed by the module 166. In one embodiment, the data may be compressed into a proprietary format (e.g., ZIP, DOC, MP3, WMA, etc.). The data may, alternatively or additionally, encrypt the data so as to prevent unauthorized parties from accessing it.

The module 166 may, in turn, transmit or send the data to the advertising server 116. The data may include the data indicative of whether the advertising content was provided in the client application 162 (e.g., the extracted information, such as the md5sum checksum code). The data may, additionally or alternatively, include the communications data, which may or may not be compressed and/or encrypted.

The data may be sent directly to the advertising server 116 and/or may be sent to the advertising server 116 using or through one or more of the proxy servers 120 and/or the content server 112. In some embodiments, the module 166 may transmit the data to one proxy server 120, which may, in turn, transmit or send the data to the advertising server 116. In other embodiments, the module 166 may transmit the data to more than one proxy server 120 to ensure that the advertising server 116 receives the data (and, e.g., that a response is not faked). In another embodiment, the content server 112 may be used when ad-blocking is preventing communications between the application 162 and the advertising server 112.

When the advertising server 116 receives the data from the module 166, the advertising server 116 may analyze this data as well as data stored or maintained on the advertising server 116 to determine whether ad-blocking software is executing on the client device 104. The data stored or maintained on the advertising server 116 may be or include what advertising content was or has been available and/or when that advertising content was available at the advertising server 116, previous communications between the client device 104 and the advertising server 116, previous communications attempts by the client device 104 and/or the advertising server 116 (e.g., contact attempts previously made by the client device 104 to the advertising server 116), previous instances in which the advertising content was successfully provided (i.e., provided to the end user 108) in the client application 162, other data or information, or combinations thereof.

In other embodiments, the module 166 may obtain or receive the data stored or maintained on the advertising server 116 (e.g., what advertising content was available) and analyze this data as well as the data indicative of whether the advertising content has been provided in the client application 162 (e.g., the extracted information, such as the md5sum checksum) and/or any communications data collected by the module 166.

Based on the analysis, a rating that is indicative of whether ad-blocking software is executing on the client device 104 may be assigned to or formed or developed for the client device 104. In other words, a rating that is indicative of whether the client application 162 is able to obtain and/or provide the advertising content may be assigned to or formed or developed for the client device 104. The rating may be provided (e.g., assigned, formed, or developed) by or at the module 166. When, for example, the analysis is performed by or at the advertising server 116, the module 166 may obtain or receive data indicative of this analysis from the advertising server 116. In other embodiments, the rating may be provided (e.g., assigned, formed, or developed) by or at the advertising server 116. In yet other embodiments, the rating may be provided by both the advertising server 116 and the module 166. For example, the advertising server 116 may provide a server-side rating and the module 166 may provide a module rating, with the total rating being a combination or reflection of the server-side rating and the module rating.

Any scale for the rating may be used. In one embodiment, the rating may be based on a scale of 1-10, with “1” being indicative or reflective of, for example, the fact that the server 116 and/or the module 166 determines there is a very low likelihood, at least based on the current data, that ad-blocking software is executing on the client device 104 and “10” being indicative or reflective of just the opposite. When, for example, data indicates that the client device 104 had access to a wireless internet connection at specified time, advertising content was available but not provided to the client device 104 or the end user 108 at the same specified time, and the client device 104 and the advertising server 116 have previously communicated with one another, the advertising server 116 and/or the module 166 may determine that the client device 104 should be assigned a rating of 10. In another embodiment, “10” may be indicative or reflective of, for example, the fact that the server 116 and/or the module 166 determines there is a very low likelihood, at least based on the current data, that ad-blocking software is executing on the client device 104. In other embodiments, other ratings, scores, or valuations may be used and/or the ratings or scores may mean or represent different things than the examples depicted herein. For example, a binary rating may be used to indicate that ad-blocking is or is not occurring. In some embodiments, the advertising server 116 may transmit this rating to the module 166.

The module 166 may compare the provided rating to a confidence threshold or level set or established by one or more advertisers, the application developer, some other party or entity, or combinations thereof. The confidence threshold or level utilizes the same scale as the rating, score, or other valuation. The confidence threshold generally represents the rating (or score or other valuation) at which the system 100 confidently believes or assumes (i.e., concludes or determines) that ad-blocking software is executing on the client device 104.

As part of this comparison, the module 166 may determine whether the rating exceeds or is greater than, is equal to, or is less than the confidence threshold. In one embodiment, when the rating exceeds the threshold, the module 166 proceeds under the assumption or determines that ad-blocking software is executing on the client device 104. Conversely, when the rating is less than or equal to the threshold, the module 166 proceeds under the assumption or determines that ad-blocking software is not executing on the client device 104. In other embodiments, when the rating exceeds the threshold, the module 166 proceeds as though ad-blocking software is not executing on the client device 104.

In other embodiments, the above-noted tasks (e.g., analyzing the data, forming a rating, comparing the rating to a threshold) may be divided differently (i.e., performed by different components of the system 100). For example, the advertising server 116, rather than the module 166, may compare the rating to a threshold and transmit or send data indicative of this comparison to the module 166.

The module 166 is configured to perform a remedial action or response when it is determined that ad-blocking software is executing on the client device 104. More specifically, the module 166 may be configured to perform a remedial action when it is determined, based on the attempted detection and/or the communications data, that ad-blocking software is executing on the client device. For example, the module 166 may be configured to perform a remedial action when the module 166 does not detect the information embedded within the advertising content. As another example, the module 166 may be configured to perform a remedial action when the rating indicates that ad-blocking software is executing on the client device 104 (e.g., the rating exceeds the pre-determined threshold).

In some embodiments, the module 166 may notify or alert the end user 108 that the system 100 has determined that ad-blocking software is executing on the client device 104. The module 166 may request a response to this notification from the end user 108.

Such a response may include paying a license, buying the client application 162, disabling (e.g., uninstalling) the ad-blocking software from the client device 104, or combinations thereof. The module 166 may provide the end user 108 with a pre-determined amount of time (e.g., 1 week) to comply with the request and perform the desired response.

Regardless of whether the module 166 notifies and requests a response from the end user 108, the module 166 may control or limit the client application 162 when it is determined that ad-blocking software is executing on the client device 104. The module 166 may control the client application 162 based on the comparison of the rating to the threshold. When the rating indicates that ad-blocking software is not executing on the client device 104 (e.g., the rating does not exceed the pre-determined threshold), the module 166 need not limit or otherwise control the client application 162. When, however, the rating indicates that ad-blocking software is executing on the client devicel04 (e.g., the rating exceeds the pre-determined threshold), the module 166 may limit the client application 162.

The module 166 may limit the client application 162 by, for example, preventing the client application 162 from downloading additional or new digital content, disabling one or more features (e.g., saving) of the client application 162, shutting down or totally disabling the client application 162, or shutting down other features of the client device 104. For example, the module 166 may shut down other software (e.g., applications) executing on the client device 104, such as software related to the client application 162 or software associated with a particular developer.

The module 166 may limit the client application 162 in response to a failure by the end user 108 to comply with a response request and perform the desired response (e.g., pay a license, disable the ad-blocking software), in response to a request by the advertising server 116, or automatically upon determining that ad-blocking software is executing on the client device 104 (i.e., the end user 108 is not offered an opportunity to respond as noted above). For example, the module 166 may disable the client application 162 in response to a failure by the end user 108 to pay a license and/or disable ad-blocking software, as requested.

When the module 166 has limited the client application 162 and the end user 108 attempts to utilize the client application 162 (e.g., download additional digital content), the module 166 may determine if the requested response has been performed, send or transmit data about the attempt to the advertising server 116 and/or the one or more proxy servers 120, contact the advertising server 116 in some other way, provide a message or alert to the end user 108, similar to the one described above, indicating that the system 100 has detected that ad-blocking software is executing on the client device 104, provide contact information, request the same or a different response (e.g., pay a license), shut down or exit the application 162, perform some additional or different task, or combinations thereof.

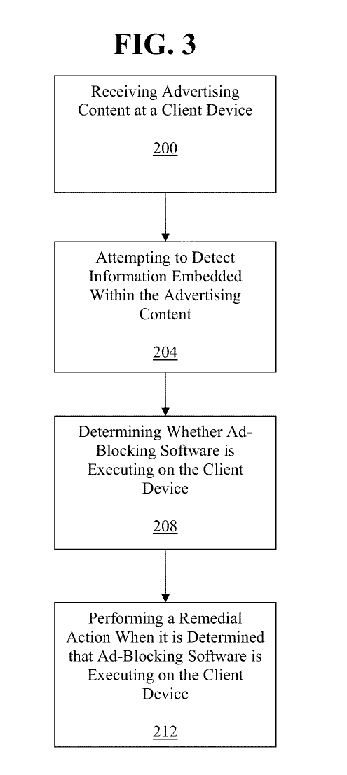

FIG. 3 shows a flow chart depicting a method or operation for determining whether ad-blocking software is executing or running on a client device (e.g., the client device 104). The method or operation may be implemented using the system 100 described above. In other embodiments, a different system may be used. The method is implemented in the order shown, but may be implemented in or according to any number of different orders. Additional, different, or fewer acts may be provided. For example, client device may transmit multiple requests for advertising content, in which case the receiving, detecting, providing, and receiving acts may be repeated. As another example, a plurality of client devices may each transmit a request for advertising content, in which case the receiving, detect, providing, and receiving acts may be repeated in connection with each request.

Advertising content may be received from an advertising server (e.g., the advertising server 116) at a client device (e.g., the client device 104) (act 200). The advertising content is to be provided in a client application (e.g., the client application 162) executing on the client device. Information or data is embedded within or into the advertising content. The information or data may be or include a code (e.g., a checksum code), an address, a tag, other information or data, or combinations thereof. The information may be embedded anywhere in the advertising content. The information may, for example, be embedded into or within graphics, such as one or more layers, channels, or pixels, or portions thereof, of the advertising content. For example, the information may be embedded into an alpha channel (e.g., an 8-bit alpha channel) of the advertising content.

The advertising content may be transmitted directly to the client device or to the client device using one or more proxy servers (e.g., one or more proxy servers 120). The advertising content may be received from the advertising server in response to a request for advertising content from the client device and/or the content server or without any specific request. In other embodiments, the request is not transmitted and/or the advertising content is not received due to ad-blocking.

The operation or method includes attempting to detect the information embedded within the advertising content at or using the client device (act 204). The attempting may include decoding or deciphering the advertising content, particularly the graphics of the advertising content, when or after the advertising content has been output, displayed, or provided in the client application. A module (e.g., the module 166) may decode or decipher the layers, channels (e.g., the alpha channel), pixels, other graphics components, or combinations thereof, of the advertising content after or when the advertising content has been output, displayed, or provided in the client application. The attempting may then include detecting, extracting, or identifying the previously embedded information from the decoded advertising content. When, for example, the embedded information is or includes a checksum code coded into an alpha channel of the advertising content, the module may decode the graphics, particularly the alpha channel, of the advertising content and extract that checksum code from the advertising content. In embodiments in which ad-blocking software is executing on the client device, the information may not be detected when the detection is attempted.

The operation or method includes determining whether ad-blocking software is executing on the client device based on the attempted detection (act 208). In some embodiments, the determining may include forming or developing a rating based on the attempted detection. The rating may be formed at or by the advertising server and/or the client device (e.g., the module executing thereon). The rating may be indicative of whether ad-blocking software is executing on the client device. The rating may be formed based on an analysis of data indicative of whether the embedded information was detected and/or communications data gathered for the client device. The communications data may include data indicative of whether a wireless internet connection is available, whether a mobile connection is available, a location of the client device, other data, or combinations thereof. In one embodiment, the determining may further include determining whether the formed rating exceeds a pre-determined threshold. When the rating exceeds the pre-determined threshold, it may be determined that ad-blocking software is executing on the client device. Any scale for the rating may be used and/or scores or valuations may be used instead of the rating.

The method or operation further includes performing a remedial action when it is determined that ad-blocking software is executing on the client device (act 212). In some embodiments, the performing may include notifying an end user (e.g., the end user 108) associated with the client device that it has been determined that ad-blocking software is executing on the client device and/or requesting a response from the end user. The response may include paying a license and/or disabling the ad-blocking software on the client device.

In some embodiments, the performing may further include limiting the client application when it is determined that ad-blocking software is executing on the client device. Limiting may, for example, include preventing the client application from downloading digital content, disabling one or more features of the client application, or shutting down the client application. The limiting may, for example, occur when the end user does not comply with the requested response (e.g., does not pay the license and/or disable the ad-blocking software).

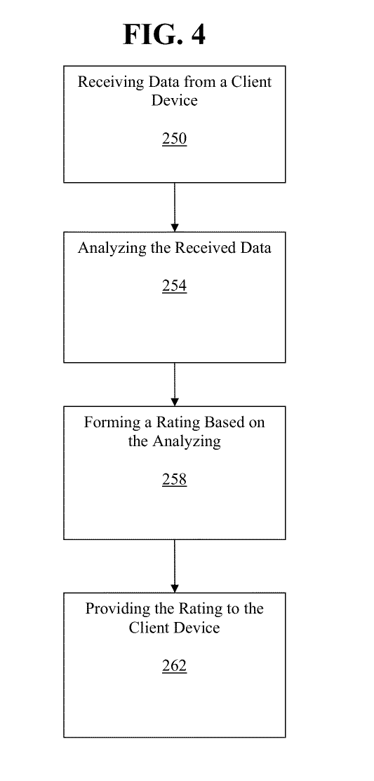

FIG. 4 shows a flow chart depicting a method or operation for determining whether ad-blocking software is executing or running on a client device (e.g., the client device 104). The method or operation may be implemented using the system 100 described above. In other embodiments, a different system may be used. The method is implemented in the order shown, but may be implemented in or according to any number of different orders. Additional, different, or fewer acts may be provided. For example, data may be received from any number of client devices. Accordingly, the analyzing, forming, and providing acts may be repeated in connection with each of these client devices.

The operation or method includes receiving, from a client device, communications data for the client device and data indicative of whether information embedded within advertising content to be provided in a client application (e.g., the client application 162) executing on the client device was detected by the client device (act 250)

The operation or method includes analyzing the received data (act 254). The analyzing may, in some embodiments, include verifying that advertising content was available from an advertising server when the client application attempted to obtain the advertising content, assessing whether the client application has previously provided advertising content, or a combination thereof.

The operation or method includes forming, based on the analyzing, a rating indicative of whether ad-blocking software is executing on the client application (act 258). The operation or method further includes providing the rating to the client device (act 262).

As noted above, the module 166, any other module, or individual components of any module may be implemented as computer program logic or computer readable program code stored in the memory and/or storage of a computer, such as the computer 300. FIG. 5 illustrates an embodiment of the computer system 300. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices. Any of the components discussed above may be a computer system 300 or a component in the computer system 300.

In a networked deployment, the computer system 300 may operate in the capacity of a server or as a client user computer in a client-server user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 5, the computer system 300 may include a processor 302, e.g., a central processing unit (CPU), a graphics processing unit (GPU), or both. The processor 302 may be a component in a variety of systems. For example, the processor 302 may be part of a standard personal computer or a workstation. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The computer system 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 304 includes a cache or random access memory for the processor 302. In alternative embodiments, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the programmed processor 302 executing the instructions stored in the memory 304. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 300 may further include a display unit 314, such as a liquid crystal display (LCD), an organic light emitting diode (OLED), a flat panel display, a solid state display, a cathode ray tube (CRT), a projector, a printer or other now known or later developed display device for outputting determined information. The display 314 may act as an interface for the user to see the functioning of the processor 302, or specifically as an interface with the software stored in the memory 304 or in the drive unit 306.

Additionally, the computer system 300 may include an input device 316 configured to allow a user to interact with any of the components of system 300. The input device 316 may be a number pad, a keyboard, or a cursor control device, such as a mouse, or a joystick, touch screen display, remote control or any other device operative to interact with the system 300.

In a particular embodiment, as depicted in FIG. 5, the computer system 300 may also include a disk or optical drive unit 306. The disk drive unit 306 may include a computer-readable medium 310 in which one or more sets of instructions 312, e.g. software, can be embedded. Further, the instructions 312 may embody one or more of the methods or logic as described herein. In a particular embodiment, the instructions 312 may reside completely, or at least partially, within the memory 304 and/or within the processor 302 during execution by the computer system 300. The memory 304 and the processor 302 also may include computer-readable media as discussed above.

The present disclosure contemplates a computer-readable medium that includes instructions 312 or receives and executes instructions 312 responsive to a propagated signal, so that a device connected to a network 320 can communicate voice, video, audio, images or any other data over the network 320. Further, the instructions 312 may be transmitted or received over the network 320 via a communication port 918. The communication port 318 may be a part of the processor 302 or may be a separate component. The communication port 318 may be created in software or may be a physical connection in hardware. The communication port 318 is configured to connect with a network 320, external media, the display 314, or any other components in system 300, or combinations thereof. The connection with the network 320 may be a physical connection, such as a wired Ethernet connection or may be established wirelessly as discussed below. Likewise, the additional connections with other components of the system 300 may be physical connections or may be established wirelessly.

The network 320 may include wired networks, wireless networks, or combinations thereof, and may be representative of the network 124, 128, 132, 136, or combinations thereof. The wireless network may be a cellular telephone network, an 802.11, 802.16, 802.20, or WiMax network. Further, the network 320 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

I claim:

1. An apparatus comprising:
at least one processor; and
at least one memory including computer program code for one or more programs,
the at least one memory and the computer program code configured to, with the at least one processor, cause the apparatus to perform at least the following:
receive advertising content from an advertising server, the advertising content to be provided in an application executing on the apparatus, the advertising content having information embedded therein;
attempt to detect the information embedded within the advertising content;
determine, based on the attempt, whether ad-blocking software is executing on the apparatus; and
perform a remedial action when it is determined that ad-blocking software is executing on the apparatus.

2. The apparatus of claim 1, wherein the at least one memory and the computer program code are configured to, with the at least one processor, cause the apparatus to:
gather communications data when the application has been executing on the apparatus for a pre-determined amount of time; and
determine, based on the attempted detection and the communications data, whether the ad-blocking software is executing on the apparatus.

3. The apparatus of claim 2, wherein the at least one memory and the computer program code are configured to, with the at least one processor, cause the apparatus to:
form a rating based on the attempted detection and the communications data, the rating indicative of whether ad-blocking software is executing on the client device; and
determine, based on the rating, whether ad-blocking software is executing on the apparatus.

4. The apparatus of claim 2, wherein the at least one memory and the computer program code are configured to, with the at least one processor, cause the apparatus to:
form a rating based on the attempted detection and the communications data, the rating indicative of whether ad-blocking software is executing on the client device;
compare the rating to a pre-determined threshold; and
determine, when the rating exceeds the pre-determined threshold, that ad-blocking software is executing on the apparatus.

5. The apparatus of claim 1, wherein the information embedded within the advertising content comprises a code embedded within graphics of the advertising content.

6. A method comprising:
receiving, at a client device, advertising content from an advertising server, the advertising content to be provided in a client application executing on the client device and having information embedded therein;
attempting to detect, via the client device, the information embedded within the advertising content;
determining, based on the attempting, whether ad-blocking software is executing on the client device; and
performing, via the client device, a remedial action when it is determined that ad-blocking software is executing on the client device.

7. The method of claim 6, further comprising: gathering, via the client device, communications data for the client device; wherein determining comprises determining, based on the attempting and the gathering, whether ad-blocking software is executing on the client device.

8. The method of claim 7, wherein the act of gathering the communications data is performed when the client application has been executing on the client device for a pre-determined period of time.

9. The method of claim 7, wherein the communications data comprises data indicative of whether a wireless internet connection is available, whether a mobile connection is available, a location of the client device, or combinations thereof.

10. The method of claim 6, wherein performing the remedial action comprises preventing the client application from downloading digital content, disabling one or more features of the client application, or shutting down the client application.

11. The method of claim 6, wherein determining comprises forming a rating based on the attempting, the rating indicative of whether ad-blocking software is executing on the client device.

12. The method of claim 11, wherein determining further comprises: determining whether the rating exceeds a threshold, and wherein, when the rating exceeds the threshold, performing the remedial action comprises notifying an end user associated with the client device that ad-blocking software is executing on the client device, and requesting a response from the end user.

13. The method of claim 12, wherein requesting the response from the end user comprises requesting that the end user pay a license or disable the ad-blocking software on the client device.

14. The method of claim 13, wherein when the end user does not pay the license or disable the ad-blocking software in response to the request, performing the remedial action further comprises limiting the client application.

15. The method of claim 6, wherein attempting comprises attempting to detect a code embedded within graphics of the advertising content.

16. A system comprising:
a client device;
a client application executing on the client device and configured to provide digital content and request advertising content from an advertising server to be displayed in the client application; and
a module installed on the client device, the module configured to attempt to detect information embedded within the advertising content,
wherein the module is configured to determine, based on the attempted detection, whether ad-blocking software is executing on the client device, and
wherein the module is configured to perform a remedial action when it is determined that ad-blocking software is executing on the client device.

17. The system of claim 16, wherein the information embedded within the advertising content comprises a code embedded within graphics of the advertising content.

18. The system of claim 16, wherein the module is configured to gather communications data for the client device when the client application has been executing on the client device for a pre-determined amount of time, the communications data including data indicative of whether a wireless internet connection is available, whether a mobile connection is available, a location of the client device, or combinations thereof, and wherein the module is configured to determine, based on the attempted detection and the communications data, whether ad-blocking software is executing on the client device.

19. The system of claim 16, wherein the module is configured to prevent the client application from obtaining additional digital content, disable one or more features of the client application, or shut down the client application when it is determined that ad-blocking software is executing on the client device.

20. A method comprising:
receiving, from a client device, communications data for the client device and data indicative of whether information embedded within advertising content to be provided in a client application executing on the client device was detected by the client device;
analyzing the received data;
forming, based on the analyzing, a rating indicative of whether ad-blocking software is executing on the client device; and
providing the rating to the client device.
